(19) United States
(12) Patent Application Publication
(10) Pub. No.: US 2006/0202862 A1
(43) Pub. Date: Sep. 14, 2006

(54) Smart Vehicle Identification System

(76) Inventor: Nitesh Ratnakar, Oak Creek, WI (US)

Correspondence Address: NITESH RATNAKAR, 8600 S. LIBERTY LN #2410, OAK CREEK, WI, 53154, US

(21) Appl. No.: 10/906,619

(22) Filed: Feb. 27, 2005

(51) Int. Cl. G08G 1/01; G08B 1/00; G08B 13/14

(52) U.S. Cl. 340/933; 340/572.1; 340/531

(57) ABSTRACT

The present invention relates to a smart vehicle identification device that has means to determine the identity of vehicles on city streets and highways. The smart vehicle identification device comprises of 1) an interrogator in the form of a radiofrequency (RF) reader; 2) wireless transceiver, modem and communication ports that serve as communication means; 3) a central processing unit comprising of a processor and memory chip that determines and controls the functioning of the smart vehicle identification device. A multitude of smart vehicle identification devices are placed strategically along highways and city streets; and each smart vehicle identification device communicates with a central control station to form a network. Transponders; comprising of radiofrequency (RF) tags; are mounted on vehicles and contain vehicle identification information. The RF reader of each smart vehicle identification device has means to interrogate the RF tag of vehicles passing through its corresponding interrogation zone on highways and city streets. Vehicle identification information thus obtained is transmitted to the central control station. Suspect vehicle identification information is entered into the computer system at the central control station; which has means to match the entered suspect vehicle identification information with the vehicle identification information obtained from the smart vehicle identification devices in its network; and determine if a suspect vehicle has been identified by a smart vehicle identification device in its network. Law enforcement officials are alerted if a suspect vehicle is identified.

### FIELD OF THE INVENTION

The present invention relates to a vehicle identification system; more specifically, to a vehicle identification system that has means to automatically identify and locate a suspect vehicle on city streets and highways; and alert law enforcement officials when a suspect vehicle is identified.

### BACKGROUND AND PRIOR ART

Criminals usually flee crime scene expeditiously to avoid getting arrested by police officers. They preferably use highways and city streets to flee as these provide a faster passageway. Frequently, general public and/or patrolling police officers have information regarding the vehicle used by criminals. In this situation, law enforcement personnel are able to determine the identity of the suspect vehicle, either completely or partially, based on information provided by witnesses or patrolling police officers. Inspite of this, locating a suspect vehicle is a tedious and challenging task. Presently, witnesses are required to call law enforcement officials and alert them of a crime situation and provide available information about the identity of the suspect vehicle. Currently, there are three systems that law enforcement officials use to identify and locate a suspect vehicle; 1) Amber Alert System; 2) manual hunt for suspect vehicle by law enforcement personnel; 3) dissemination of information to the general public about the crime and identity of suspect vehicle; and enlisting general public's help to identify and locate the said suspect vehicle.

1) Amber Alert System: In January 1996, nine year old Amber Hagerman was riding her bicycle when a neighbor heard the girl scream. The neighbor saw a man pull Amber off her bike, throw her into the front seat of his pickup truck, and drive away at a high speed. The neighbor called police and provided a description of the suspect and his vehicle, but couldn't recall much else. Arlington, Tex., police and the FBI interviewed other neighbors and searched for the suspect and vehicle. Local radio and TV stations covered the story in their regular newscasts. Four days later, Amber's body was found in a drainage ditch four miles away. Her throat has been cut. Her kidnapping and murder remain unsolved. A concerned citizen contacted a Dallas, Tex. radio station suggesting the idea that Dallas radio stations should repeat news bulletins about abducted children just like they do severe weather warnings. The idea was presented to the general managers of the radio stations in the Dallas/Fort Worth area. They agreed that such a program would provide an important public service and might help save the life of a child. Thus ‘AMBER’ plan was conceived. Although the Amber Plan is named after Amber Hagerman, this national program is dedicated to all children nationwide who've been abducted. According to the U.S. Department of justice, up to 4600 children are abducted by strangers every year (about 12 children nationwide every day). The ‘amber alert’ system is a voluntary partnership between law enforcement agencies and broadcasters to activate an urgent bulletin in the most serious child abduction cases. Broadcasters use the Emergency Alert System (EAS), formerly called the Emergency Broadcast System, to air a description of the abducted child, suspected abductor and the suspect vehicle. This is the same concept used during severe weather emergencies. The goal of the ‘amber alert’ is to instantly galvanize the entire community to assist in the search for and safe return of the child. Although the scope of the ‘amber alert’ varies, the criteria for activation are fairly consistent. Whether it is a local, regional or statewide program, law enforcement activates an ‘amber alert’ by notifying broadcast media with relevant identifying and case information when circumstances meets the following criteria: 1) The missing child is of a pre-determined age; 2) The law enforcement agency believes the child has been kidnapped; 3) The agency believes the missing child is under threat of serious bodily harm or death. Once they receive the “amber alert”; radio and television stations interrupt regularly scheduled programming to notify the public that a child has been kidnapped. Because 95% of all people driving in their cars listen to the radio, this is an extremely effective way of providing descriptions of the child, the kidnapper, vehicles or accomplices. Besides turning the public into instant investigators when children are kidnapped, benefits of the ‘amber alert’ include: 1) It is free; 2) It encourages participation between natural adversaries, law enforcement and media by drawing on their inherent strengths; 3) It promotes accountability by creating the foundation of a comprehensive missing child protocol; 4) It is an effective time critical response to kidnappers who can disappear with children at the rate of a mile per minute; 5) It sends a powerful message to ‘wanna-be’ kidnappers that we are a community that cares about and protects children; 6) It saves lives; 7) ‘Amber alert’ system enables dissemination of suspect vehicle identification information to the general public and enable them to identify and locate a suspect vehicle on highways and city streets.

2) Manual Hunt by Police Officers: Amber alert system is not applicable to majority of crime situations as it is only activated under certain circumstances. Fact of the matter is, that for majority of crimes, the entire responsibility to locate and intercept a suspect vehicle lie with the law enforcement agencies. With the current system, law enforcement officials are required to manually look for a suspect vehicle while patrolling. This is often a difficult task, especially in big cities with millions of vehicles. This is true even when complete and specific identification information of a suspect vehicle; such as license plate number or vehicle registration number; is known. The task of locating a suspect vehicle is even tougher when only limited vehicle identification information; like vehicle make, model, year, color and the like; is available. It is especially difficult in large cities where hundreds, or even thousands, of vehicles may fit the description of the suspect vehicle. In addition, it is common for law enforcement officials to be on the look out for more than one suspect vehicle at any given time, which makes the task of locating a suspect vehicle even more challenging. It is also important to remember that looking out for a suspect vehicle is not the only responsibility that police officers on patrol have. They often have many other responsibilities, which in some situations, supercede the responsibility of finding a suspect vehicle.

3) Enlist General Public's Help: Sometimes, law enforcement officials enlist the help of general public by means of broadcast media. In such a situation, the general public has to assimilate information about the crime situation, along with suspect vehicle and criminal identification information. Subsequently, they have to be on the look out for the suspect vehicle while driving on the streets. Once an individual identifies a vehicle that fits the description of the said suspect vehicle, he/she alerts the law enforcement agencies. Police officers are then dispatched to the location of the identified suspect vehicle to further investigate the information provided.

Disadvantages of the Present System: The present system of locating and intercepting suspect vehicles, as discussed in the preceding paragraphs, has the following shortcomings; 1) it is time consuming, as the suspect vehicle identification information has to be communicated to many concerned parties. It becomes even more time consuming when general public has to be involved as it involves dissemination of information by broadcast media. The end result is that it is often too late by the time a suspect vehicle is found. 2) it is expensive to disseminate information to general public via broadcast media; 3) it is often difficult for most people to fully or partially remember suspect vehicle identification information which may lead to; a) a wrong vehicle being reported; b) even more concerning is the possibility that the suspect vehicle may go unrecognized; 4) looking for a suspect vehicle and trying to determine if a vehicle fits the description of a suspect vehicle while driving is dangerous, especially on highways. This practice diverts a driver's attention from the task of driving and may cause fatal accidents; 5) sometimes, law enforcement agencies have to offer financial incentives to the general public to enlist their help in locating a suspect vehicle. Often, such financial incentives are substantial, sometimes amounting to millions of dollars. This is certainly a drain on the financial resources of law enforcement agencies, which often are on a tight budget; 6) even when police officers are able to locate a suspect vehicle, they commonly have to pursue the suspect vehicle in a high speed car chase, which has the following disadvantages; a) often, high speed car chase is a very risky undertaking as the driver of a suspect vehicle drives at dangerously high speeds and often breaks traffic rules; endangering the safety of police officers, other drivers and pedestrians; b) commonly requires involvement of helicopters to track a fleeing suspect vehicle; which is very costly; c) even more concerning is the fact that sometimes, offending drivers escape police chase and remain free to commit another crime; d) sometimes high speed car chase end in tragic outcomes.

### OBJECTS OF THE INVENTION

Accordingly, there is a need for a vehicle identification and locator system that would enable law enforcement officials to identify, locate and track a suspect vehicle more effectively and efficiently; without the need to; 1) manually be on the lookout for the said suspect vehicle; 2) engage in high speed car chase; 3) spend large amounts of money; 4) divert significant law enforcement resources from other activities. The object of the present invention is to design a vehicle identification and locator system that has means to; 1) automatically identify a suspect vehicle on highways and city streets; 2) determine the location of the said suspect vehicle; 3) alert law enforcement personnel when the said suspect vehicle is identified; 4) track the said suspect vehicle as it is driven through city streets and highways and give law enforcement officials real time location of the said suspect vehicle.

### SUMMARY OF THE INVENTION

The present invention utilizes radiofrequency identification (RFID) technology. Radiofrequency tags (RF tags) are provided; that are mounted on the license plates of vehicles. The RF tags contain vehicle identification information comprising of vehicle registration number, license plate number, make, model, year, color of the vehicle, owner identification information and any other information relating to vehicle identity. ‘Vehicle Identification Devices’ comprising of radiofrequency reader (RF reader), are strategically placed along highways and city streets. A multitude of ‘vehicle identification devices’ are connected to a central control station to form a network. The central control station has an array of computers that forms the ‘central computer system’. The central computer system contains data regarding the location of each vehicle identification device in its network; and this data is arranged in a fashion such that information received from a particular vehicle identification device can be readily linked to its location. The vehicle identification devices interrogate the RF tag of vehicles passing through their respective interrogation zones; obtain vehicle identification information contained therein; and transmit the obtained information to the central control station. Suspect vehicle identification data is entered into the central computer system at the central control station. The central computer system has means to match the entered suspect vehicle identification information with the vehicle identification information obtained from vehicle identification devices in its network; and determine if the said suspect vehicle is present in its network area. If so, it alerts law enforcement officials.

### BRIEF DESCRIPTION OF THE DRAWINGS

FIG. 1A shows an outside view of the ‘vehicle identification device’.

FIG. 1B shows an inside view of the ‘vehicle identification device’.

FIG. 1C illustrates the two way connection between the central processing unit of the ‘vehicle identification device’ and its other components.

FIG. 2 shows a radiofrequency tag (RF tag) mounted on the license plate of a vehicle.

FIG. 3 illustrates the two way communication between the RF tag and the RF reader; and it illustrates the communication of information stored in the RF tag to an onboard display unit present in the vehicle.

FIG. 4 illustrates the network formed by a multitude of ‘vehicle identification devices’ communicating with a central control station; which in turn communicates with law enforcement and other authorized personnel.

FIG. 5A illustrates a method whereby; information obtained by the RF reader is transmitted to the central control station where it is processed and follow up action is determined.

FIG. 5B illustrates a method whereby; information obtained by the RF reader is processed; and follow up action determined at the ‘vehicle identification device’ level.

### DETAILED DESCRIPTION OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out one or several purposes of the present invention. It is important, therefore, that the claims be regarded as including such equivalent constructions insofar as they do not depart from the spirit and scope of the present invention.

The vehicle identification and locator system of the present invention utilizes radiofrequency identification (RFID) technology. RFID technology is a radio communication system that communicates between a radio transceiver, called an ‘Interrogator’ or ‘Reader’, and a number of inexpensive devices denoted as ‘Tags’ or ‘Transponders’. RF tags provide a means of obtaining data without direct contact such as is needed with magnetic strip or bar code technology. Such tags have been around for some time. U.S. Pat. No. 3,713,148 issued to Cardullo et al. on Jan. 23, 1973, and incorporated herein by reference, describes a tag, which includes a changeable or writable memory. The tags are self-contained in hermetically sealed capsules or laminates requiring no external power since they get power by rectifying the energy in a field created by the interrogator and storing the energy in capacitive-type circuitry. Nevertheless, some tags may be powered with small batteries. RF tags come in a variety of embodiments from a thin, flat and flexible form-factor (thin type) to small capsules (cylindrical type). An example of a thin form-factor is described in U.S. Pat. No. 5,528,222 issued to Moskowitz et al in 1996. In RF system, the reader communicates with the tags using modulated radio signals, which activate any tag in range; or a specific tag within the range. After activating a tag, the reader may transmit information to it (this is called the downlink). The reader transmits a continuous-wave (CW) radio signal to the tag; the tag then modulates the CW signal using modulated backscattering (MBS) in which the tag is electrically switched by the modulating signal, from being an absorber of RF radiation to a reflector of RF radiation. This modulated backscatter allows communications from the tag back to the reader (called the uplink). The downlink transmission of messages can include information relating to a desired operation of the RF tag and, for example, the reader is capable of instructing the RF tag to turn on and/or off on demand.

RF tags come in two varieties: active and passive. An active RF tag includes a battery or other power source, and is activated by a signal from a reading device. The activated RF tag then broadcasts its identification or other data, which is picked up by the reading device. An advantage of active RF tags over passive RF tags is that the inclusion of a power source allows the active RF tag to transmit to a receiver without entering into an electromagnetic field to power the tag circuit. Active RF tags are also generally able to transmit over a longer distance. The advantages of active RF tags has led to its use in automatic toll-paying systems, or the like. However, an active RF tag has certain disadvantages compared to a passive RF tag. For example, because the active RF tag requires a battery or other power source, it is more expensive and heavier than a passive RF tag. Additionally, the active RF tag becomes useless when the battery or other power source is depleted. Passive RF tags have no power supply per se, but power is provided to the RF circuitry by using an electromagnetic power receiver. The RF reading device sends power to the RF tag's electromagnetic power receiver, thus powering up or turning on the RF tag's circuits. Next, the passive RF tag broadcasts a response signal containing identification or other information, which is then read by the reading device. Because the passive RF tag has no battery, it is less expensive and lighter. Passive RF tags have been in use for some time, notably in security access cards where the user holds the card near the card reader to unlock a door, and in clothing stores as security tags attached to clothing items. Either of these technologies can be used with the vehicle identification system of the present invention; depending of the desired features; and should not be considered limiting.

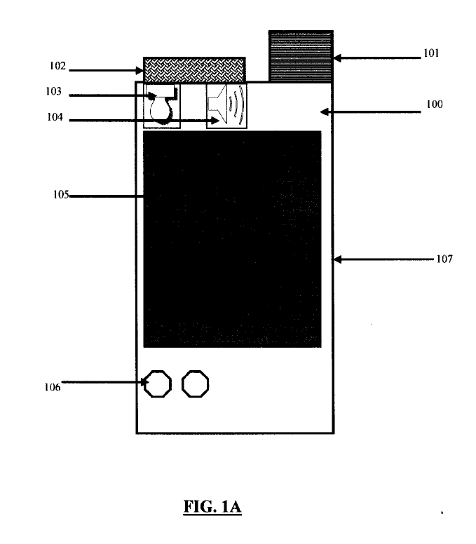

FIGS. 1A &1B show ‘Vehicle identification device’ (100) of the present invention. The vehicle identification device (100) comprises of an interrogator, which in the preferred embodiment, is a radiofrequency (RF) reader (101). The RF reader (101) has an interrogation range that covers a predetermined area of the highway or city street (interrogation zone) and has means to interrogate the RF tag (201) of vehicles passing through its corresponding interrogation zone. In addition to the interrogator, the vehicle identification device (100) contains a central processing unit (CPU; 112) comprising of a processor (113) and a memory chip (114). A modem (115), two-way wireless transceiver (116) and communication ports (120) are provided; which serve as communication means for the vehicle identification device (100). An internal clock (117) and timer (117); with means to control and trigger time sensitive functions; are provided in the vehicle identification device (100). The vehicle identification device (100) is enclosed in a housing (107), which preferably, is made of a tamper proof, weather and water resistant material. A display unit, which in the preferred embodiment is a liquid crystal display (LCD) screen (105), is provided in the housing (107). The housing (107) also has a visual (103) and an audio (104) alarm. A plurality of control switches (106) is provided that enables local command entry into the vehicle identification device (100). Commands can also be entered into the vehicle identification device (100) via the display unit (105) using touch screen technology or using an external keyboard attached to the vehicle identification device (100). Command can also be entered into the smart vehicle identification device (100) remotely via the modem (115) or the wireless transceiver (116). A battery compartment (119) is located in the housing, which holds one or more batteries to power the vehicle identification device (100). In the preferred embodiment, the battery is a solar battery, but it may be of any other kind like lithium, nickel etc. A solar panel (102) to charge the solar battery is provided. An electrical terminal (121) for connection to an external source of power is also provided. As shown in FIG. 1C, the CPU of the vehicle identification device has two way communication with other components of the vehicle identification device (100) including RF reader, modem, wireless transceiver, clock, timer and display unit. The CPU (112) controls and determines the functioning of the smart vehicle identification device (100).

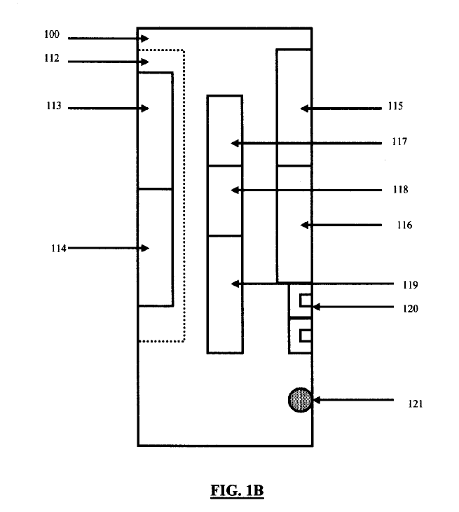

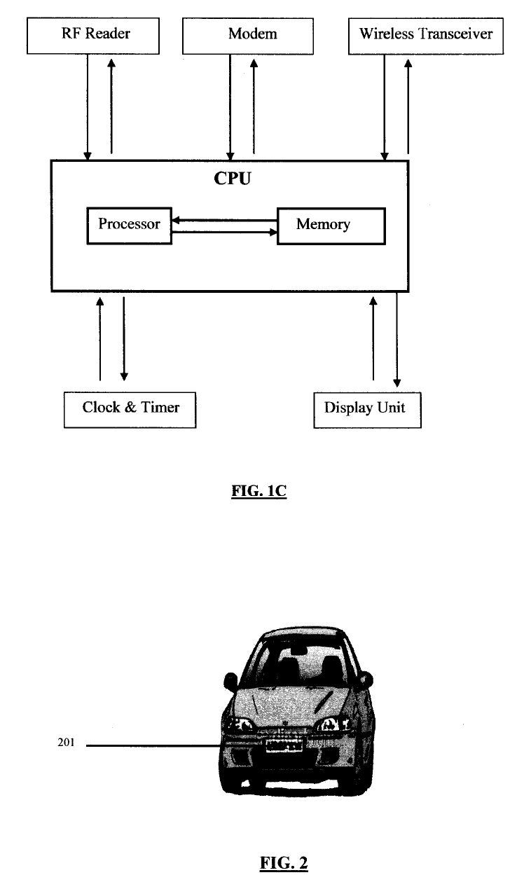

Transponder is provided in vehicles, which in the preferred embodiment is a radiofrequency tag (RF tag; 201) and is mounted on the license plate of as shown in FIG. 2; or it can be present anywhere in the vehicle. In the preferred embodiment, the RF tag (201) is a passive tag but it could also be an active RF tag connected to a power source such as car battery. The RF tag (201) stores vehicle identification information like registration number, license plate number, vehicle identification number (VIN), year, make, model, color, owners name and contact information and the like. The information contained in the RF tag (201) can be updated whenever necessary, for example when there is change of ownership of the vehicle. Alternately, vehicle identification information, including registration number, license plate number, VIN, make, model and year of the vehicle and the like is stored in a central computer system, which maintains a database containing information pertaining to all vehicles. Individual vehicle identification data is linked to a unique serial number stored in the RF tag (201) of the corresponding vehicle. The said database at the central control station is organized such that reference is made to vehicles by their respective RF tag serial numbers; and data linked to a corresponding RF tag serial number can be readily pulled. Either of these two methods can be used with the present invention and should not be considered limiting. As shown in FIG. 3, the RF tag (201) is connected to an onboard display unit in the vehicle which enables display of information contained in the RF tag (201) for the benefit of drivers. FIG. 3 also illustrates that the RF tag (201) has means to store data received from the RF reader (101) of the vehicle identification device (100).

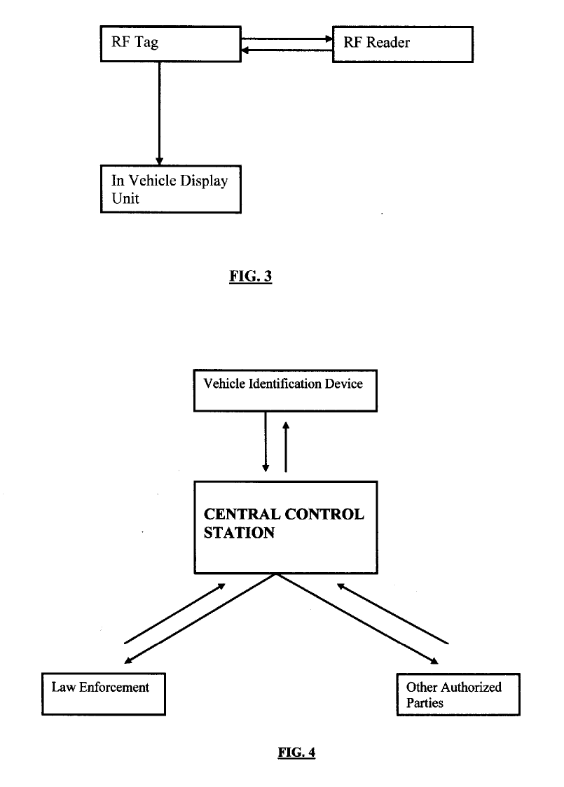

Vehicle identification devices (100) are strategically placed along highways and city streets. A multitude of vehicle identification devices (100) communicate with a central control station to form a network as shown in FIG. 4. The said network can be city wide, county wide, state wide, country side or can cover a geographic area of any size. The central control station has means to communicate with remote parties like police officers. The central control station has an array of computers that form the ‘central computer system’. In the preferred embodiment, the communication between the vehicle identification devices (100) and the central control station is wireless; however the vehicle identification devices (100) can also be connected to the central control station by a wired network. The central computer system stores data regarding the location of each vehicle identification device (100) in its network; and this data is arranged in a fashion such that information received from a particular vehicle identification device (100) can be readily linked to its location. In the preferred embodiment, the vehicle identification device (100) is powered by solar batteries; however an electrical terminal (121) for connection to an external source of power is also provided. Although in the preferred embodiment, the transponder is a radiofrequency transponder, other transponders like Surface Acoustic Wave (SAW) transponder or a Dense Wave Multiple Access (DWMA) transponder may be used. Similarly, although the term “radio frequency” is used, other parts of the electromagnetic spectrum may be used to create the energy field. UHF, microwave and millimeter wave sources may be used by the reader; depending on the distance between the reader and the tag; and the material to be penetrated. In the preferred embodiment, the vehicle identification devices (100) are activated by law enforcement officials when they are searching for a suspect vehicle. Alternatively, the vehicle identification devices (100) can be programmed to remain active indefinitely, in which case, all information obtained from the vehicle identification devices (100), present and past, is stored in the central computer system. One advantage of keeping the vehicle identification devices (100) active indefinitely is that law enforcement officials will be able to determine the location of a suspect vehicle during a specified time period in the past. This information may be useful in apprehending and prosecuting criminals.

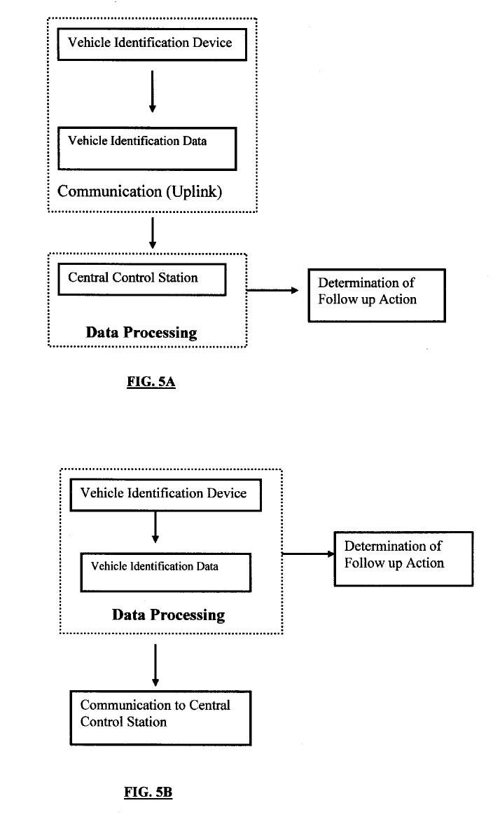

The interrogation zone of the RF reader of each vehicle identification device (100) is enough to cover a pre determined area of the highway or city street and to interrogate the RF tag (201) of vehicles passing through its corresponding interrogation zone. After interrogating the RF tag (201) of vehicles passing through their corresponding interrogation zones; the vehicle identification devices (100) transmit the information thus obtained to the central computer system as shown in FIG. 5A. The central computer system is programmed to analyze the obtained data and determine a follow up action. The central computer system receives and stores data from all vehicle identification devices (100) within its network. Identification data of a suspect vehicle is entered into the central computer system. The central computer system is programmed to match the information obtained from the vehicle identification devices (100) to the entered suspect vehicle identification information. Suspect vehicle identification information may be specific; such as vehicle registration number, vehicle identification number (VIN) and the like. In such a situation, the central computer system matches the vehicle identification data obtained from vehicle identification devices (100) within its network with the suspect vehicle identification information and determines if the said suspect vehicle is present in its network area. If so, it alerts the designated officials, who then alert police officials in the area where the suspect vehicle is detected. Location of a suspect vehicle is determined by identifying the location of the vehicle identification device (100) that detected the suspect vehicle. Often law enforcement officials have only limited identification information about a suspect vehicle. Such information may consist of a combination of one or more of; vehicle make, model, year, color and the like. The available suspect vehicle identification information is fed into the central computer system; which matches the available suspect vehicle identification information with the vehicle identification database obtained from the vehicle identification devices (100) in its network. It then comes up with a list of vehicles matching the available description of the suspect vehicle. Location of suspect vehicles is determined by identifying the location of vehicle identification devices (100) that detected the corresponding suspect vehicle. Police officers in the area where a suspect vehicle is identified are informed of the possibility of the suspect vehicle being in their area. The central control station can also instruct the vehicle identification devices (100) in the area where suspect vehicle is identified to give a local visual or audio alarm to alert nearby police officers.

According to another envisioned system as illustrated in FIG. 5B, suspect vehicle identification information is remotely entered into the vehicle identification devices (100) using a remote programming device or by the central control station. The vehicle identification devices (100) interrogate the RF tag (201) of vehicles passing through their corresponding interrogation zones and obtain vehicle identification information. Each vehicle identification device (100) is programmed to match the vehicle identification information obtained by its RF reader (102) to the entered suspect vehicle information; and determine if a vehicle matching the description of a suspect vehicle is identified. If a suspect vehicle is identified, the smart vehicle identification device (100) alerts law enforcement personnel. This is accomplished by sending a wireless message to law enforcement personnel or by giving a local audio and/or visual alarm to alert nearby police officers.

When a suspect vehicle is identified, the vehicle identification device (100) is instructed to transmit information to that effect, to the RF tag of the said suspect vehicle, where after the information is displayed on the onboard display unit in the suspect vehicle as illustrated in FIG. 3. This notifies the driver of the fact that he/she has been identified. This may be helpful in convincing the driver to stop and surrender to police; which may avoid a risky high speed car chase. Moreover, as a suspect vehicle is driven through city streets and highways, it is identified by successive vehicle identification devices (100). It gives law enforcement officials real time location of the suspect vehicle. This again helps to avoid high speed car chase as the suspect vehicle is electronically followed and can be intercepted at a convenient location and time; without the need to engage in a risky high speed car chase.

We believe our invention will result in more secure neighborhoods and enable law enforcement officials to more quickly and efficiently identify, apprehend and prosecute criminals.

What is claimed is:

1. A method of locating a vehicle comprising of:
a. A transponder; containing vehicle identification information; located in vehicles
b. A vehicle identification device; comprising of an interrogator; placed along streets or highways
c. The vehicle identification device interrogating the transponder of vehicles passing through its interrogation zone.

2. The transponder of claim 1, wherein it is a radiofrequency tag.

3. The vehicle identification device of claim 1, wherein the interrogator is a radiofrequency reader.

4. The vehicle identification device of claim 1 wherein it has means to communicate with remote parties.

5. The method of locating a vehicle of claim 1 wherein; a multitude of vehicle identification devices communicate with a central control station to form a network.

6. The method of locating a vehicle of claim 1 wherein; the vehicle identification device transmits the vehicle identification information obtained by its interrogator to a central control station.

7. The method of locating a vehicle of claim 1 wherein; the central control station has means to determine if a specified vehicle has been detected by a vehicle identification device in its network.

8. The method of locating a vehicle of claim 1 wherein; the vehicle identification device has means to determine if a specified vehicle has been detected by its interrogator.

9. The method of locating a vehicle of claim 1 wherein; the central control station has means to notify remote parties when a specified vehicle is detected.

10. The method of locating a vehicle of claim 1 wherein; the vehicle identification device has means to notify remote parties when a specified vehicle is detected.

11. The method of locating a vehicle of claim 1 wherein; the vehicle identification device has means to give a local alarm when a specified vehicle is detected.

12. A method of following a suspect vehicle as it is driven through city streets and highways comprising of the vehicle locator system of claim 1 wherein; a suspect vehicle is identified by successive vehicle identification devices as it is driven through city streets and highways.

13. A method of notifying drivers that they have been detected comprising of the vehicle locator system of claim 1 wherein;
a. the vehicle identification device transmits information to the transponder present in the suspect vehicle
b. the transponder transmits this information to an onboard display unit present in the suspect vehicle
c. the said information is displayed on the onboard display unit present in the vehicle.

14. A central computer system with means to communicate with one or more vehicle identification devices placed along streets wherein; the vehicle identification devices have means to identify vehicles passing through their corresponding interrogation zones.

15. The central computer system of claim 14 wherein; it has means to determine if a specified vehicle has been detected by a vehicle identification device in its network.

16. Transponder, containing vehicle identification information, present in or mounted on vehicles.

17. The transponder of claim 16 wherein; it is a radiofrequency tag.

18. A vehicle identification device comprising of an interrogator wherein; the interrogator has means to determine the identity of a vehicle.

19. The vehicle identification device of claim 18 wherein; the interrogator is a radiofrequency reader.

20. The vehicle identification device of claim 18 wherein; it has means to determine the identity of a vehicle while the said vehicle is in motion.
